(19) United States
(12) Patent Application Publication
(10) Pub. No.: US 2015/0199357 A1
(43) Pub. Date: Jul. 16, 2015

(54) SELECTING PRIMARY RESOURCES

(71) Applicants: Yong Soo Hwang, Seoul (KR); Junyoung Lee, Mountain View, CA (US)

(72) Inventors: Yong Soo Hwang, Seoul (KR); Junyoung Lee, Mountain View, CA (US)

(73) Assignee: GOOGLE INC., Mountain View, CA (US)

(21) Appl. No.: 13/087,074

(22) Filed: Apr. 14, 2011

(51) Int. Cl. G06F 17/30

(52) U.S. Cl. CPC G06F 17/3053; G06F 17/30958

(57) ABSTRACT

Methods, systems, and apparatus, including computer programs encoded on a computer storage medium, for selecting primary resources. In one aspect, a method includes generating a hierarchical model of an Internet domain, where each node of the hierarchical model corresponds to a resource in the domain, generating, for each of one or more criteria, a score for each node in the hierarchical model, the one or more criteria including the positions of the nodes in the hierarchical model, selecting, for a particular node in the hierarchical model, one or more descendant nodes of the particular node based on the respective scores associated with the descendant nodes, and designating resources corresponding to the one or more descendant nodes as primary resources for the resource corresponding to the particular node.

### BACKGROUND

The present specification relates to information retrieval.

The World Wide Web provides an ever-increasing number of web pages. Users often face the challenge of locating useful information among the many available web pages. At times, it can be difficult for users to distinguish web pages that include useful and relevant information from web pages that include less useful information. In some instances, users visit several web pages before successfully navigating to a web page that includes information that meets their needs.

### SUMMARY

To facilitate navigation to high quality web pages, pages hosted in a particular domain are scored based on the extent to which they include certain characteristics that are indicative of high quality content. High quality content can include, for example, web pages that provide important services, or that include content that users are likely to enjoy. Particular web pages are designated as “primary resources” based on their respective scores. The web pages that have been designated as primary resources for a particular domain can be highlighted on a search engine results page, to bring the fact that a particular web page may include high quality content to the attention of a user.

Implementations of techniques described in this specification select resources of a domain using multiple criteria to make it likely that useful, high-quality web pages are selected as the primary resources. Such criteria may include or exclude criteria relating to past visits, by the current user or by other users, to web pages under evaluation. In excluding such criteria, implementations of these techniques do not require access to search engine history logs.

As used in this specification, the term “domain” refers broadly to the entire name space of a particular domain name (e.g., “example.com”). For example, a domain includes subdomains of the particular domain name and all Uniform

Resource Locators (URLs) that include the domain name or associated subdomains. Resources are referred to as being in the domain when the resources are accessible at URLs in the domain. In other words, resources accessible at URLs that share a common domain name or hostname (or subdivision thereof) are all considered to “belong” to and be located in the same domain.

In general, an innovative aspect of the subject matter described in this specification may be embodied in methods that include the actions of generating a hierarchical model of an Internet domain, where each node of the hierarchical model corresponds to a resource in the domain and the position of each node in the hierarchical model is based on a path and hostname of a URL for the resource corresponding to the node; generating, for each of one or more criteria, a score for each node in the hierarchical model, the one or more criteria including the positions of the nodes in the hierarchical model; selecting, for a particular node in the hierarchical model, one or more descendant nodes of the particular node based on the respective scores associated with the descendant nodes; and designating resources corresponding to the one or more descendant nodes as primary resources for the resource corresponding to the particular node.

Other embodiments of this aspect include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

These and other embodiments may each optionally include one or more of the following features. For instance, the scores are generated and the one or more descendant nodes are selected without using information indicating traffic to the resources corresponding to the descendant nodes. The hierarchical model is a directed acyclic graph. Providing for display a link to the resource corresponding to the particular node, and providing for display, in association with the link to the resource corresponding to the particular node, links to the primary resources for the resource corresponding to the particular node, without providing links to non-primary resources for display in association with the link to the resource corresponding to the particular node, where non-primary resources are resources in the domain that are not designated as primary resources. Designating resources corresponding to the one or more descendant nodes as primary resources for the resource corresponding to the particular node includes storing information identifying the primary resources in association with information identifying the resource corresponding to the particular node. The one or more criteria include a link analysis score of the respective resources corresponding to the nodes in the hierarchical model. The one or more criteria include a count of how many descendant nodes the respective nodes have in the hierarchical model. The one or more criteria include a distance through the hierarchical model between the particular node and the respective nodes in the hierarchical model. The one or more criteria include a quality measure for content of the respective resources corresponding to the nodes in the hierarchical model. The one or more criteria include a count of links from within the domain to the respective resources corresponding to the nodes in the hierarchical model, and a count of links from outside the domain to the respective resources corresponding to the nodes in the hierarchical model.

Particular embodiments of the subject matter described in this specification can be implemented so as to realize one or more of the following advantages. Important resources in a domain can be brought to the attention of users based on multiple criteria, and may be designated as primary resources, to allow users to visually filter noteworthy resources from other resources. Links to primary resources can be provided to facilitate navigation to important destination resources in the domain. Web pages may be designated as primary resources without analyzing prior visits by other users to the web pages.

The details of one or more embodiments are set forth in the accompanying drawings and the description below. Other features and advantages will become apparent from the description, the drawings, and the claims.

### BRIEF DESCRIPTION OF THE DRAWINGS

FIG. 1 is a diagram of an example system that can select primary resources.

FIG. 2 illustrates an example hierarchical model of a domain.

FIG. 3 is a flow chart illustrating an example process for selecting primary resources.

Like reference numbers and designations in the various drawings indicate like elements.

### DETAILED DESCRIPTION

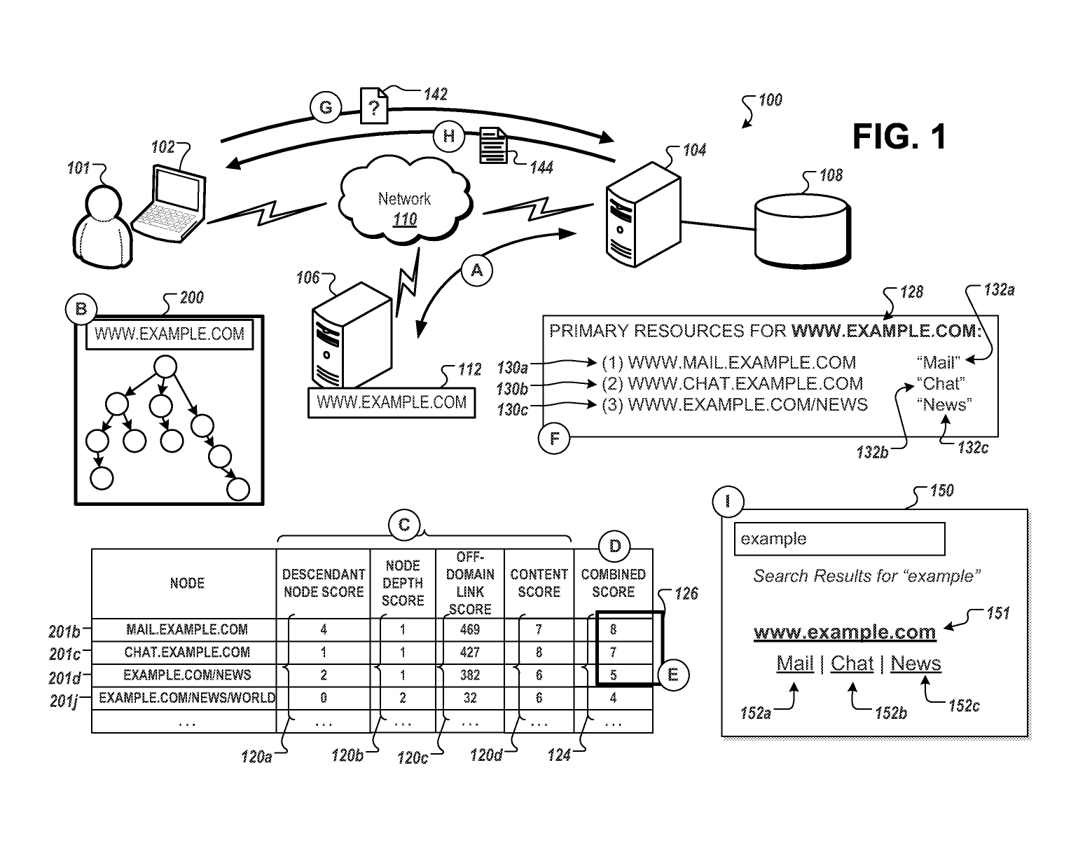

FIG. 1 is a diagram of an example system that can select primary resources. The system 100 includes a client device 102, a server system 104, a content server 106, one or more data storage devices 108, and a network 110. Examples of client devices 102 include desktop computers, laptop computers, cellular phones, tablet computers, and navigation systems. The functions performed by the server system 104 and the content server 106 can be performed by individual computer systems or can be distributed across multiple computer systems. The network 110 can be wired or wireless or a combination of both and can include the Internet. The diagram shows states (A) to (I), which may occur in the sequence illustrated or in a different sequence. States (A) to (I) illustrate a flow of data, and state (I) illustrates a user interface 150.

A domain (in the figure, “example.com”) can include resources (e.g., web pages and files) that include content relating to many different topics and services. Of those resources, some resources can have broader applicability and greater usefulness than other resources. For example, resources that provide the core services or content of a domain, e.g., product sales, e-mail service, online chat service, and news, can be more useful to users than resources related to ancillary topics and generic information, e.g., a privacy policy, contact information, boilerplate information, advertising information, and career information.

To help users navigate effectively to resources in the domain, the resources corresponding to important content and services can be selected and designated as primary resources. The primary resources can be selected based on, for example, the relationships between resources in the domain, the navigational utility the resources provide, and the content of the resources. Multiple criteria can be used to determine the relative importance of the resources in the domain so that the most important resources are likely selected as primary resources.

Links to the primary resources can be provided to users, or can be visually distinguished from links to resources that are not primary resources, to help users navigate to important destinations in the domain. Links to primary resources provide users access to important resources in the domain without navigation through intermediate resources.

The server system 104 generates a hierarchical model of the domain. The hierarchical model indicates relationships between the resources in the domain, where the relationships are determined based on analysis of the URLs for the resources. Each resource represented in the hierarchical model is assigned a position in the hierarchical model. The hierarchical model of a domain corresponds to a tree in which the root node corresponds to the domain URL.

The hierarchical model can be built by adding nodes to the model based on the host ID and path elements that appear in the URLs of the resources of the domain. The host ID elements, indicating subdomains of the domain, are considered first. The URLs do not need to be processed in any particular order to build the model. The path in the model from the root node to a resource corresponds to (i) the host ID elements of the URL of the resource, which are traversed first, and (ii) the path elements of the URL of the resource. Each additional subdomain and path element in a URL corresponds to a step to a lower level in the hierarchy. Although the hierarchical model indicates hierarchical relationships among resources, the hierarchical model may be represented by any convenient data structure, which may or may not have a hierarchical structure.

For example, the server system 104 can generate a tree structure in which nodes in the tree each correspond to a resource in the domain. The server system 104 generates a score for each node based on one or more criteria. The server system 104 selects a subset of the nodes based on the scores, and designates the resources corresponding to the selected nodes as primary resources, where the subset can include all or fewer than all of the nodes. The server system 104 can provide information identifying the primary resources by, for example, providing links to the primary resources for display on a user interface.

During state (A), the server system 104 accesses resources within a domain 112. The domain name (“example.com”) of the domain 112 can be a second-level domain name or higher-level domain name, i.e., not merely a top-level domain, such as “.com” or “.net”. In the example, the domain 112 has a second-level domain name, “example.com”. The scope of the domain 112 includes “example.com”, all subdomains thereof, e.g., third- and higher-level domains such as “mail.example.com”, “new.mail.example.com”, etc., and all URLs having paths that include those domains, e.g., “rss.news.example.com/current”.

The server system 104 accesses resources in the domain 112 by, for example, crawling the domain 112 or accessing information about the resources from a cache or index stored in the one or more data storage devices 108, which may be in one or more locations.

During state (B), the server system 104 generates a hierarchical model 200 of the resources in the domain 112. The server system 104 can determine relationships between resources in the domain 112 based on, for example, the URLs of the resources in the domain 112. In some implementations, the hierarchical model 200 can be generated using the URLs of the resources independent of the links between resources in the domain 112. The position of a resource in the hierarchical model relative to other resources in the domain 112 is thus determined based on the content of the URL for the resource and not based on links to and from the resource.

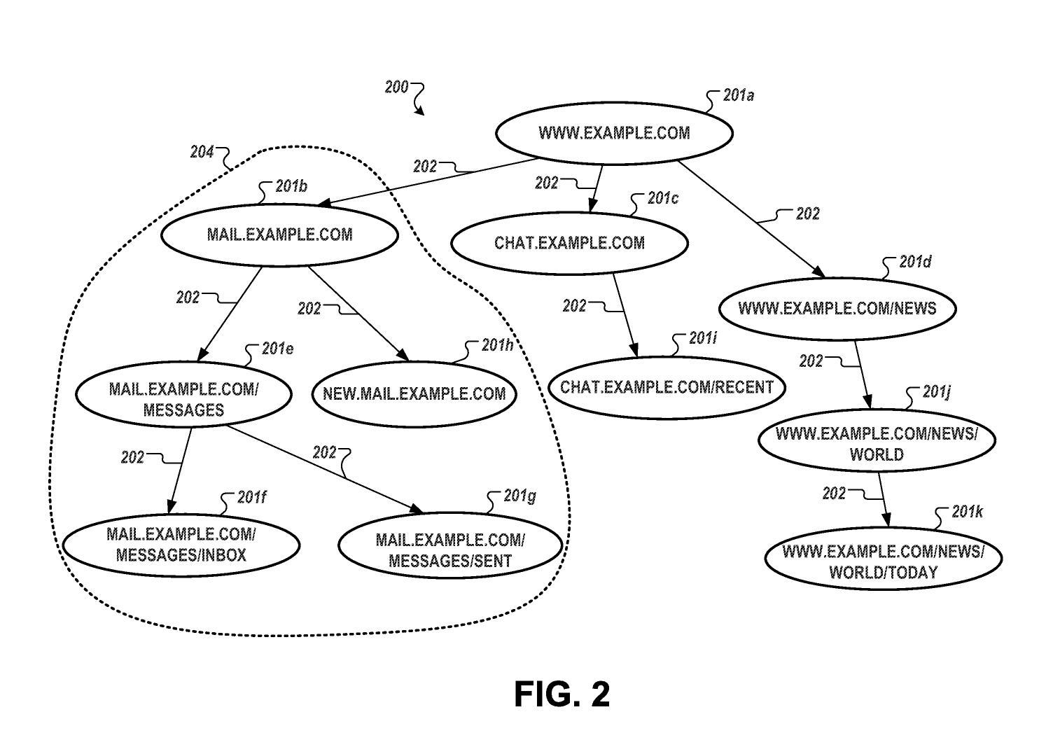

FIG. 2 illustrates an example hierarchical model 200 of the domain 112. The hierarchical model 200 can be represented using a data structure such as a graph, a tree, a list, a table, an array, or an index. As illustrated, the hierarchical model 200 is represented as a directed acyclic graph having nodes 201a-201k and edges 202 between the nodes 201a-201k. Each node 201a-201k corresponds to a resource that is accessible at a particular URL. In general, each node 201a-201k can correspond to a resource with different domain, host name, and/or path in the domain 112.

The edges 202 indicate hierarchical relationships among the nodes 201a-201k. In some implementations, each edge 202 is considered as having the same length. In some implementations, no more than a single connection exists between any pair of nodes. An edge 202 beginning at a first node 201a and pointing to a second node 201 b indicates that the second node 201a is a direct descendant of the first node 201a. In the hierarchical model 200, the root node 201a has descendant nodes 201b-201k, by virtue of edges 202 extending from the root node 201a and edges 202 extending from other nodes. The descendant nodes 201b-201k include direct or immediate descendant nodes 201b-201d, i.e., child nodes, which are one edge 202 below the root node 201a in the hierarchical model 200. The descendant nodes 201b-201k also include other descendant nodes 201e-201k, grandchild nodes, great-grandchild nodes, etc., which are positioned two or more edges 202 below the root node 201a.

To determine the relative positions of the nodes 201a-201k in the hierarchical model 200, the server system 104 examines the URLs of the resources in the domain 112. The server system 104 uses the URL for each resource to determine the position of its corresponding node 201a-201k in the hierarchical model 200. Links from one resource to another resource do not influence the relative positions of the nodes 201a-201k.

For example, the server system 104 can use the resource identifier in a URL to determine the position of nodes 201a-201k in the hierarchical model 200. The resource identifier is generally included in a URL following the host name. In particular, the server system 104 can identify path elements (“path”) in the resource identifier of the URLs, and can determine edges 202 and the positions of the nodes 201a-201k using the path. For the node 201j, which corresponds to the resource that has the URL of “www.example.com/news/world”, the path is the portion “/news/world”, which follows the hostname “www.example.com”. The path for the node 201j includes two levels, “/news” and “/world”. Because the path includes two levels, the server system 104 can determine that the node 201j should be positioned two edges 202 from the root node 201a, and one connection from the node 201d.

The server system 104 can also determine the positions of the nodes 201a-201k using subdomains of the domain 112. Information indicating a subdomain can be located, for example, in a server name or host name. For example, the root node 201a corresponds to a resource with a host name of “www.example.com”. The node 201b corresponds to a resource with a host name of “mail.example.com”, which is a first-level subdomain of “www.example.com”. Because the resource corresponding to the node 201b is a first-level subdomain, the node 201b is positioned as a first-level descendant node of the root node 201a. A second-level subdomain, for example, the node 201h corresponding to “new.mail.example.com” can be positioned as an immediate descendant of the node 201b and a second-level descendant of the root node 201a.

Nodes 201a-201k corresponding to resources in a particular subdomain are positioned as descendant nodes 201a-201k of the node representing the subdomain. For example, one branch 204 of the hierarchical model 200 includes the nodes 201e-201f, which correspond to resources in the subdomain “mail.example.com”. The path information for the nodes 201e-201f, e.g., “/messages” for the node 201e, and “/messages/inbox” for the node 201g, can be used to determine the positions of the nodes 201e-201f from the node 201b, which is the node corresponding to the subdomain.

A server system 104 can employ a number of techniques to enhance the quality of the hierarchical model 200. For example, resources with identical content (or content that the server system 104 has determined is equivalent content) can be identified and can be represented by a single node 201a-201k in the hierarchical model 200.

To identify equivalent resources, the server system 104 can generate a fingerprint, such as a hash code or checksum, for each resource, and compare the fingerprints for multiple resources. Based on the fingerprints, the server system can identify resources with identical content. In some implementations, a locality-sensitive hash function can be used to determine whether content in multiple resources exceeds a threshold level of similarity, and is thus equivalent. From a group of equivalent resources, the server system 104 can select a single resource, for example, a resource that the server system 104 determines to be of highest quality in the group. A node can be included in the hierarchical model to correspond to the selected resource, and nodes for the equivalent resources can be omitted.

In some instances, navigation to a particular a URL in the domain 112 will cause the user to be redirected to another URL. The server system 104 can identify URLs for resources that cause redirection and can also identify destination URLs that are reached after redirection. In some implementations, destination URLs can be associated with nodes 201a-201k associated with the URLs that cause the redirection. In some implementations, resources that cause redirection away from the domain 112 may be excluded from the hierarchical model 200.

In some implementations, a hierarchical model 200 can be generated for a subset of the resources in a domain rather than for the domain as a whole. For example, beginning with the URL “mail.example.com”, the server system 104 can generate a hierarchical model that includes only the subset 204. In other words, the server system 104 may obtain a particular URL and may create a hierarchical model that includes only that particular URL and its descendants, for example, resources having a URL with the same hostname but a deeper URL path than the particular URL.

As shown in FIG. 1, during state (C), the server system 104 generates scores 120a-120d for each of the nodes 201a-201k for each of one or more criteria. Each set of scores 120a-120d can provide information about the resources corresponding to the nodes 201a-201k with respect to a particular criterion. For example, each of the scores 120a corresponds to a particular node 201a-201k and is determined according to a first criterion; each of the scores 120b corresponds to a particular node 201a-201k and is determined according to a second criterion; and so on. In some implementations, the respective scores 120a-120d only appear as terms in a calculation of a composite score, such as the combined scores 124 described below.

The criteria used to score the nodes 201a-201k can include, for example, for a particular node: (1) the number of descendant nodes in the hierarchical model; (2) the depth of the node 201a-201k in the hierarchical model 200; (3) the number of links to the resource corresponding to the node from other resources in the domain 112; (4) the number of links to the resource corresponding to the node from resources outside the domain 112; (5) a link analysis score of the resource corresponding to the node; and (6) a measure of the quality of the content of the node. Examples of scores based on these criteria are described below. Each of the scores described below, including the scores 120a-120d, may be generated as absolute scores, e.g., on a standardized or objective scale, or as relative scores determined with respect to other nodes.

### (1) Descendant Scores 120a

The server system 104 can assign a descendant score 120a to each node 201a-201k. For a particular node, the associated descendant score 120a can be based on the number of descendant nodes included in hierarchical model 200 for the particular node. In general, a node with many descendant nodes may be more useful to a user than a node with few descendant nodes. For example, a resource corresponding to a node having many descendant nodes likely presents a user with many different navigational options. By contrast, a resource corresponding to a node that has few descendant nodes may provide limited navigational options to a user. Thus the descendant scores 120a can indicate higher utility resources corresponding to nodes with higher numbers of descendant nodes. In some implementations, the descendant scores 120a may be based on a number of immediate descendant nodes in addition to, or instead of, the total number of descendant nodes.

### (2) Node Depth Scores 120b

The server system 104 can also assign a node depth score 120b to each node 201a-201k. For a particular node, the node depth score 120b can be based on the position of the particular node in the hierarchical model 200 relative to one or more other nodes, for example, the distance between the particular node from a particular ancestor node. For example, the node depth scores 120b can be based on the number of edges 202 in the shortest path through the hierarchical model 200 between the respective nodes 201a-201k and a particular ancestor node, such as the root node 201a. There is one edge 202 between the node 201b and the root node 201a, so the node 201b can be assigned a node depth score 120b of “1”. Similarly, there are two edges 202 in the shortest path between the node 201j and the node 201a, so the node 201j can be assigned a node depth score 120b of “2”.

In some implementations, the node depth score 120b can be calculated for a particular ancestor node other than the root node. For example, to select primary resources for the resource corresponding to the node 201b, the server system 104 can determine the node depth scores 120b, or other scores 120a-120d, with respect to the node 201b.

In general, the lower the node depth of a particular node, the higher the importance of the resource corresponding to the particular node 201a-201k. For example, resources corresponding to a node with a low node depth are likely to be related to important services offered by a domain 112 and to be related to topics of general applicability. By contrast, resources corresponding to nodes with a high node depth may be related to very narrow topics that may not be broadly applicable to users attempting to navigate in the domain 112. Thus the node depth scores 120b can indicate the higher utility of resources corresponding to nodes with a low node depth.

### (3) Off-domain Link Scores 120c

The server system 104 can also assign an off-domain link score 120c to each node 201a-201k. Off-domain links are links included in resources in a domain different from the domain 112. Consequently, the off-domain link score 120c for a particular node is based on a count of links to the resource corresponding to the particular node that are included in resources outside the domain 112. In some implementations, the server system 104 uses a partial count of off-domain links to the respective resources rather than attempting to find all links.

To generate the off-domain link scores 120c, the server system 104 can access an index stored in the one or more data storage devices 108 that includes information about links to the resources in the domain 112. In particular, the index can include information about links to the resources that correspond to the nodes 201a-201k. Using this information, the server system 104 can count the links occurring outside the domain 112 to each node 201a-201k. The server system 104 can generate the off-domain link scores 120c such that nodes corresponding to resources with many off-domain links are indicated to be more important than nodes corresponding to resources with few off-domain links. For example, as illustrated, higher off-domain link scores 120c indicate higher importance of associated nodes 201a-201k and their corresponding resources.

### (4) On-domain Link Scores

The server system 104 can also assign an on-domain link score (not illustrated) to each node 201a-201k. On-domain links are links included in resources in the domain 112. The on-domain link score for each node 201a-201k can be based on, for example, a count of on-domain links to the resource corresponding to each node 201a-201k. The on-domain link scores can indicate that nodes corresponding to resources with many on-domain links are more important than nodes 201a-201k corresponding to resources with fewer on-domain links.

### (5) Link Analysis Scores

The server system 104 can also assign to each node 201a-201k a link analysis score (not illustrated). A link analysis score can be based on, for example, the PageRank algorithm, described, for example, in Lawrence Page, Sergey Brin, Rajeev Motwani, Terry Winograd, The PageRank Citation Ranking: Bringing Order to the Web, Technical Report, Stanford InfoLab (1999), http://ilpubs.stanford.edu:8090/422/. As with the off-domain link scores 120c and the on-domain link scores, the link analysis scores can indicate the importance of the nodes 201a-201k and their corresponding resources. For example, the link analysis scores can indicate not only the quantity of links to the resources in the domain, but also the quality or importance of those links.

### (6) Content Scores 120d

The server system 104 can also assign a content score 120d to each node 201a-201k. The content score 120d assigned to a particular node can be based on the content of the resource corresponding to the particular node. For example, the content scores 120d can indicate a level of quality, e.g., high quality, medium quality, or low quality, of the content of the resources corresponding to the respective nodes 201a-201k.

As an example, the server system 104 may determine the content scores 120d using one or more titles identified in the resources corresponding to the respective nodes 201a-201k. The content scores 120d can indicate a measure of quality of the titles. For example, the score for a node can be based on the degree that a title for the resource corresponding to the node matches anchor text of links to the resource. The greater the degree of match between the anchors and the title, and the greater the percentage of anchors or number of anchors that match the title, the higher the quality of the title and thus the higher the content score 120d of the corresponding node 201a-201k.

In some implementations, the server system 104 can score a node based on characteristics of resources in the domain 112 that are determined to be equivalent to the node's corresponding resource. For example, when the resource corresponding to a node is selected from a set of equivalent resources, scores for the node can be based on information for multiple equivalent resources in the set. For example, when determining the off-domain link-score, the server system 104 may assign a score to a node based on a count of off-domain links to any of the resources in a set of equivalent resources, not only based on a count of off-domain links to the corresponding resource. Alternatively, scores may be based on an average for a set of equivalent resources.

During state (D), in some implementations, the server system 104 generates a combined score 124 for each node 201a-201k using the respective scores 120a-120d generated during state (C). The server system 104 generates the combined scores 124 based on two or more scores 120a-120d. For example, the server system 104 can generate weighted averages of two or more scores 120a-120d as combined scores 124 for the respective nodes 201a-201k. To generate the combined scores 124, the server system 104 can normalize, scale, invert, or otherwise adjust the scores 120a-120d to facilitate combination.

Because the combined scores 124 are based on information determined using multiple criteria, e.g., the criteria used to generate the scores 120a-120d, the combined scores 124 can provide a better measure of the importance and utility of the nodes 201a-201k than individual scores based on any single criterion.

Through the information in the scores 120a-120d, the combined scores 124 can incorporate information about different aspects of the nodes 201a-201k and their corresponding resources. For example, the combined scores 124 can incorporate information about the position of a resource in the structure of the domain 112, e.g., using the node level scores 120a. The combined scores 124 can also incorporate information about the navigational utility of a resource to a user. For example, the node level scores 120a and the descendant scores 120b can indicate nodes that provide access to many navigational options in the domain 112, thus reducing the likelihood that the user will navigate to a dead end without reaching a useful destination. The combined scores 124 can also incorporate information about measure of the quality of the content of a resource. For example, resource quality can be indicated directly using the content quality scores 120d, or indirectly using the off-domain link scores 120c or link analysis scores.

In the illustrated example, the higher the combined score 124, the higher the deemed importance, quality, and utility for navigation of the nodes 201a-201k and their corresponding resources. Other scoring systems can also be used. For example, in some implementations, the combined scores 124 may be calculated such that lower scores indicate more useful nodes 201a-201k and corresponding resources.

When combining the scores 120a-120d, the server system 104 can impose a penalty for nodes 201a-201k that have low off-domain link scores 120c. In some instances, the absence of off-domain links to a resource can indicate that the resource corresponding to a node 201a-201k is very low quality or is a “spam” resource. Accordingly, when the server system 104 determines that there are no off-domain links or very few off-domain links to a resource corresponding to a particular node, the server system 104 can reduce the combined score 124 of the particular node.

In some implementations, generating combined scores 124 can include comparing each of one or more scores 120a-120d to a threshold. Nodes that do not satisfy one or more thresholds can be determined to correspond to non-primary resources. For example, a minimum threshold of “1” can be set for the off-domain link scores 120c. The server system 104 can compare the off-domain link score 120c for each node 201a-201k to the threshold. Nodes 201a-201k associated with an off-domain link score 120c that is less than the minimum threshold can be assigned a combined score 124 of zero, or can be otherwise designated as corresponding to a non-primary resource. Similarly, thresholds can be set for one or more of the other scores 120a, 120b, 120d. In some implementations, a combined score 124 for a node 201a-201k may be generated only when multiple scores 120a-120d associated with the node 201a-201k each satisfy corresponding thresholds.

During state (E), the server system 104 selects one or more nodes 201a-201k based on one or more of the scores 120a-120d, 124. The server system 104 selects the nodes 201a-201k from among the descendant nodes of a particular reference node, which may or may not be the root node 201a. In some instances, the all of the descendant nodes of the reference node can be selected. To select nodes based on the scores 120a-120d, 124, the server system 104 can, for example, select nodes 201a-201k having scores 120a-120d, 124 above one or more thresholds, or select a particular number of nodes 201a-201k having the highest or lowest scores.

For example, the server system 104 can select a subset 126 of the nodes 201a-201k using the combined scores 124. For a particular reference node, the server system 104 selects, based on the combined scores 124, the subset 126 that includes one or more descendant nodes of the reference node. For example, the server system 104 can select the subset 126 to include the N nodes having the highest combined scores 124, where N is a predetermined number of primary resources to be selected.

In the illustrated example, the reference node is the root node 201a. The server system 104 selects the subset 126 from among the descendant nodes 201b-201k of the reference node 201 a. In the example, N equals three, and so the server system 104 selects the subset 126 to include the three nodes 201b-201d which have the highest combined scores 124.

During state (F), the server system 104 designates the resources corresponding to the selected nodes 201b-201d as primary resources 130a-130c for the resource corresponding to the reference node 201a of state (E). The resource corresponding to the reference node 201a will be referred to as the “reference resource” 128. Because the combined scores 124 are deemed to indicate the importance of the resources corresponding to the nodes 201a-201k, and because the primary resources 130a-130c are selected based on the combined scores 124, the primary resources 130a-130c are expected to include the resources that are most useful to a user navigating through the domain 112. In particular, the primary resources 130a-130c are expected to be the most useful navigational resources in a particular portion of a domain 112, for example, the portion of the domain 112 that corresponds to the descendant nodes 201b-201k of the reference node 201a.

The server system 104 can store information that identifies the association of the primary resources 130a-130c as primary resources of the reference resource 128. For example, information identifying the primary resources 130a-130c can be stored in the one or more data storage devices 108 in association with information identifying the reference resource 128. In other words, information is stored that indicates that the primary resources 130a-130c are primary resources for the reference resource 128. Information identifying the primary resources 130a-130c and information identifying the reference resource 128 can be stored together or in separate locations.

The server system 104 can also rank the primary resources 130a-130c according to the combined scores 124 associated with their respective nodes 201b-201d. The server system 104 can also assign a title 132a-132c to each of the primary resources 130a-130c. Each assigned title 132a-132c can be based on, for example, a title identified in the content of a corresponding primary resource 130a-130c or in a URL of a corresponding primary resource 130a-130c.

The server system 104 can remove a portion of an identified title for a primary resource that is redundant to a title of the reference resource 128. For example, the title for the reference resource having the URL “www.example.com” may be “Example” and the title for the primary resource 130a having the URL “mail.example.com” may be “Example Mail.” The server system 104 can determine that the identified title of the primary resource 130a includes a prefix “Example” that matches a portion of the title for the reference resource 128. As a result, the server system 104 removes the prefix so that the assigned title 132a for the primary resource 130a is “Mail.”

During state (G), the user 101 of the client device 102 causes a request 142 to be sent to the server system 104 that includes a search query.

During state (H), the server system 104 sends information to the client device 102 in response to the request 142. For example, in the illustrated example, the server system 104 sends a web page 144 that indicates results for the search query in the request 142. The results identify at least the reference resource 128. The server system 104 can access information about the primary resources 130a-130c associated with the reference resource 128, which information is stored in the one or more data storage devices 108, to respond to the request 142. For example, the server system 104 can access information that identifies the primary resources 130a-130c for the reference resource 128 when the reference resource 128 is a result for the search query.

During state (I), the information sent to the client device 102 by the server system 104 is displayed on a user interface 150 of the client device 102. The user interface 150 displays information identifying the reference resource 128 and information identifying the primary resources associated with the reference resource 128. For example, the user interface 150 includes a first link 151 to the reference resource 128, which is indicated on the user interface 150 as a result for the search query. In association with the first link 151, the user interface 150 includes primary links 152a-152c, which respectively provide access to the primary resources 130a-130c. The primary links 152a-152c can be displayed in an order based on the ranking of the primary resources 130a-130c, for example, according to the combined scores of the nodes 201a-201k. Alternatively, the primary links 152a-152c can be displayed in an alphabetical order.

The primary links 152a-152c permit the user 101 to easily navigate to any of the primary resources 130a-130c. Rather than navigate through a series of resources in the domain 112 to reach one of the primary resources 130a-130c, the user 101 can navigate directly to one of the primary resources 130a-130c using the primary links 152a-152c. The user 101, who may be unfamiliar with the content and services provided in the domain 112, can also identify and navigate to several important destinations in the domain 112 from the single user interface 150.

In some implementations, the number of primary links and primary resources can vary based on one or more parameters. For example, the number of primary links displayed on a user interface 150 or provided by the server system 104 can vary according to the screen size of the client device 102. For example, depending on the screen size of smartphones, three to five primary links may be displayed. For a computer or a device with a large screen, eight or more primary links may be displayed. Accordingly, primary links for only some of the primary resources designated for a reference resource 128 may be displayed. The server system 104 can determine, based on information provided in the request 142 or otherwise, the type of client device 102 that sent the request 142. The server system 104 can include in the information provided to the client device 102 an appropriate number of primary links for the type of client device 102 determined.

The primary links can include the text of the titles for the respective primary resources 130a-130c. As a result, the primary links 152a-152c can indicate the services, topics, and areas of interest available in the domain 112 of the reference resource 128.

In some implementations, the designation of primary resources for the reference resource does not vary according to the content of the request 142. In other words, regardless of the terms of the search query included in the request 142, each time the first link 151 for the reference resource 128 occurs in a listing of search results, the server system 104 can provide the primary links 152a-152c to the same primary resources 130a-130c.

Additional variations are possible. For example, in some implementations, the server system 104 preforms the operations described in reference to states (E) and (F) for multiple different reference nodes. The server system 104 selects a subset of descendant nodes for each of the multiple reference nodes based on the combined scores 124. The server system 104 can select a subset of descendant nodes for each of the nodes.

The resources corresponding to the nodes in each subset are designated as primary resources for the reference resource with which the subset is associated. For example, a subset selected for the node 201b can include the nodes 201e, 201f, 201h. As a result, the resources corresponding to the nodes 201e, 201f, 201h, respectively having URLs “mail.example.com/messages”, “mail.example.com/messages/inbox”, and “new.mail.example.com/”, are designated as primary resources for the resource having the URL “mail.example.com”, which corresponds to the node 201b. In this manner, different sets of primary resources can be designated for different resources in the domain 112.

In some implementations, the particular resources selected and designated as primary resources 130a-130c for a reference resource 128 can change. For example, over time the number and content of resources in the domain 112 may change. In some instances, the criteria used for selecting the primary resources 130a-130c can change. Accordingly, to re-select primary resources, the operations described in reference to states (A) to (F) can be repeated for an entire domain 112 or for a particular reference resource 128 and its corresponding dependent resources. New primary resources for a reference resource 128 can be selected, for example, in response to detecting changes in a domain 112 or after a period of time has elapsed.

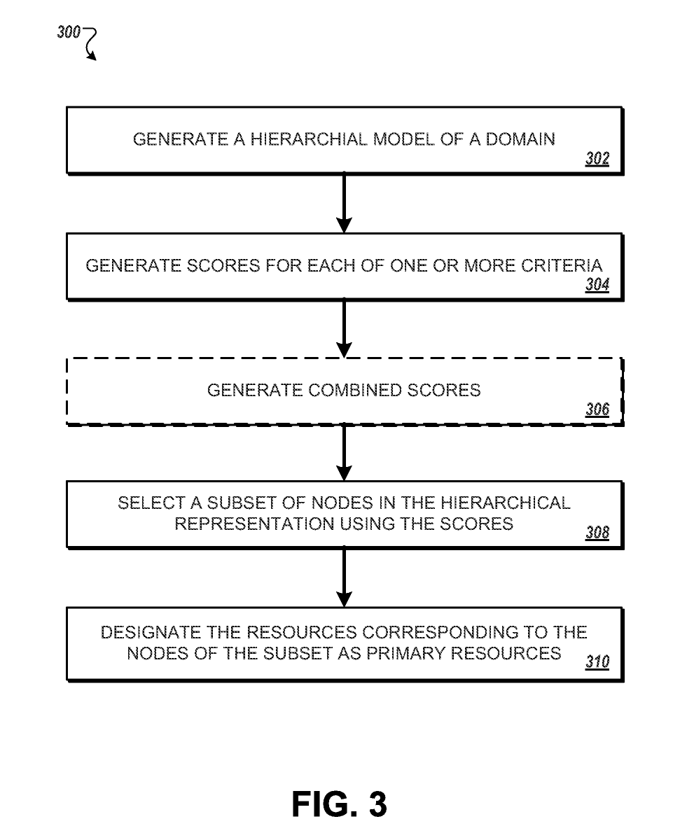

FIG. 3 is a flow chart illustrating an example process for selecting primary resources, generating a hierarchical model of a domain where each node in the hierarchical model corresponds to a resource in the domain, and generating a score for each node for each of one or more criteria. The process also includes generating a combined score for each node, selecting a subset of a particular node's descendant nodes based on the respective combined scores, and designating resources corresponding to the descendant nodes of the subset as primary resources of the particular node.

In further detail, a hierarchical model of a domain is built (302). Each node of the hierarchical model corresponds to a resource in the domain. The position of each node in the hierarchical model is determined based on a path and hostname of a URL for the resource corresponding to the node. The positions of the nodes in the hierarchical model are independent of links between resources in the domain. Each node can correspond to multiple resources in the domain. The hierarchical model can represent only a portion of the domain. The hierarchical model can represent the domain as graph structure, for example, as a tree.

A score for each node in the hierarchical model is generated for each of one or more criteria (304). The criteria can include the positions of the nodes in the hierarchical model. The positions of the nodes include relative positions, i.e., the positions of one or more of the nodes in the hierarchical model relative to the positions one or more of the other nodes in the hierarchical model. For example, the criteria can include a count of descendant nodes of the respective nodes in the hierarchical model. The criteria can include a node depth of the nodes in the hierarchical model. When the hierarchical model is a tree structure, for example, the node depth for a node can be a distance from the root node of the tree. The positions of nodes in the hierarchal model and the node depth can be based on, for example, the URL path depth of resources corresponding to the nodes.

The criteria can include a quality measure for content of the respective resources corresponding to the nodes in the hierarchical model. The criteria can include a number of links from within the domain to the respective resources corresponding to the nodes in the hierarchical model. The criteria can include a number of links from outside the domain to the respective resources corresponding to the nodes in the hierarchical model.

The scores be generated independent of traffic patterns to resources in the domain. For example, the criteria can exclude characteristics of traffic to the resources in the domain such that scores are generated without using traffic information or query logs. As a result, the scores can be generated even when traffic to resources in the domain is very low or if traffic characteristics are unknown.

Optionally, in some implementations, a combined score for each node is generated using the generated scores (306). For example, a single combined score can be generated for each node using two or more scores generated for different criteria. A weighted average of two or more scores can be used to generate a combined score for a node.

For a particular node in the hierarchical model, a subset of descendant nodes of the particular node is selected based on the respective scores associated with the descendant nodes (308). For example, if combined scores are calculated for the nodes, the subset can be selected based on the combined scores for the respective nodes. The particular node can be the root node of the hierarchical model or the particular node can be another node. The descendant nodes can include indirect descendant nodes. In some implementations, the descendant nodes include only immediate descendant nodes.

Because the scores for the nodes can be generated without using traffic information for resources in the domain, the descendant nodes can be selected without using information indicating traffic to resources in the domain. Thus the dependent nodes are selected independent of relative traffic to the resources corresponding to the nodes.

Resources corresponding to the descendant nodes of the subset are designated as primary resources of the particular node (310). Designating primary resources can include storing information that identifies the primary resources and information associating it with information that identifies the resource corresponding to the particular node.

In some implementations, the process 300 can include determining whether query logs and/or traffic information are available for a domain. If such information is available, resources with higher traffic relative to other resources in the domain can be more likely to be selected as primary resources. If traffic information is not available, the process 300 can be performed to select primary resources without using such information. Similarly, the process 300 can be performed in response to determining that the amount of measured traffic to resources in a domain is below a threshold level or that the amount of data in the query logs for the domain is below a threshold amount.

The process 300 can include providing for display a link to the resource corresponding to the particular node of (308). The process 300 can also include providing for display, in association with the link to the resource, links to the primary resources. The links to the primary resources may be associated with the link to the resource by virtue of, for example, display on a common interface, a common location within a bounded region or frame, proximity on a visual display, or commonalities in formatting, or markings indicating that the primary links are associated with the resource. For example, the primary links may be provided for display immediately below the link to the resource, a title for the resource, or a description of or portion of the resource. The placement of primary links on a display may closer to the link to the resource than the placement of non-primary links. In some implementations, only links to primary resources are provided in association with the link to the resource corresponding to the particular node.

In some implementations, non-primary links may be simultaneously displayed in a single user interface with primary links. Non-primary resources include, for example, resources in the domain that are not designated as primary resources. Links to non-primary resources can be visually distinguished from the primary links. Links to non-primary resources can be displayed yet excluded from association with the first resource. Thus links to primary resources and non-primary resources can be displayed together, but links to primary resources can be distinguished from the non-primary resources due to, for example, size, typeface, formatting, highlighting, placement at particular locations on a user interface, placement relative to the link to the first resource, and/or other visual features.

A number of implementations have been described. Nevertheless, it will be understood that various modifications may be made consistent with this specification.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments can be implemented in a computing system that includes a back end component, e.g., as a data server, or that includes a middleware component, e.g., an application server, or that includes a front end component, e.g., a client computer having a graphical user interface or a Web browser through which a user can interact with an implementation, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the techniques described herein or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments have been described. Other embodiments are within the scope of the following claims. For example, the steps recited in the claims can be performed in a different order and still achieve desirable results.

What is claimed is:

1. A computer-implemented method comprising:
generating a hierarchical sitemap of an Internet domain;
generating a score for a particular node in the generated hierarchical sitemap of the Internet domain, based at least on a position of the particular node in the generated hierarchical sitemap of the Internet domain; and
classifying a resource corresponding to the particular node as a primary resource based at least on the score for the particular node.

2-61. (canceled)

62. The computer-implemented method of claim 1, wherein generating the score for the particular node in the generated hierarchical sitemap of the Internet domain, based at least on the position of the particular node in the generated hierarchical sitemap of the Internet domain comprises:
generating the score for the particular node in the generated hierarchical sitemap of the Internet domain based on evaluating a quantity of descendent nodes the particular node has in the generated hierarchical sitemap of the Internet domain.

63. The computer-implemented method of claim 1, wherein generating the score for the particular node in the generated hierarchical sitemap of the Internet domain, based at least on the position of the particular node in the generated hierarchical sitemap of the Internet domain comprises:
generating the score for the particular node in the generated hierarchical sitemap of the Internet domain based on a distance through the generated hierarchical sitemap of the Internet domain between the particular node and the respective nodes in the generated hierarchical sitemap of the Internet domain.

64. The computer-implemented method of claim 1, wherein generating the score for the particular node in the generated hierarchical sitemap of the Internet domain, based at least on the position of the particular node in the generated hierarchical sitemap of the Internet domain comprises:
generating the score for the particular node in the generated hierarchical sitemap of the Internet domain without using information indicating traffic to the resource corresponding to the particular node.

65. The computer-implemented method of claim 1, wherein generating the score for the particular node in the generated hierarchical sitemap of the Internet domain, based at least on the position of the particular node in the generated hierarchical sitemap of the Internet domain comprises:
evaluating a quality measure for content of the respective resource corresponding to the particular node in the generated hierarchical sitemap of the Internet domain.

66. The computer-implemented method of claim 1, wherein each node of the generated hierarchical sitemap of the Internet domain corresponds to a resource in the Internet domain and a position of each node in the generated hierarchical sitemap of the Internet domain is based on a path and hostname of a URL for the resource corresponding to the node.

67. The computer-implemented method of claim 66, wherein generating the score for the particular node in the generated hierarchical sitemap of the Internet domain, based at least on the position of the particular node in the generated hierarchical sitemap of the Internet domain comprises:
evaluating a link analysis score of the resource corresponding to the particular node in the generated hierarchical sitemap of the Internet domain.

68. The computer-implemented method of claim 66, wherein generating the score for the particular node in the generated hierarchical sitemap of the Internet domain, based at least on the position of the particular node in the generated hierarchical sitemap of the Internet domain comprises:
evaluating a count of links from within the Internet domain to the resource corresponding to the particular node in the generated hierarchical sitemap of the Internet domain; and
evaluating a count of links from outside the Internet domain to the resource corresponding to the particular node in the generated hierarchical sitemap of the Internet domain.

69. The computer-implemented method of claim 66, comprising:
generating, for each of multiple criteria, a score for each node in the generated hierarchical sitemap of the Internet domain;
generating a combined score for each node in the generated hierarchical sitemap of the Internet domain based on the respective score for two or more of the multiple criteria;
selecting, for the particular node in the generated hierarchical sitemap of the Internet domain, one or more descendent nodes of the particular node based on the respective combined scores associated with the descendent nodes; and
designating resources corresponding to the one or more descendent nodes as primary resources for the resource corresponding to the particular node.

70. The computer-implemented method of claim 69, comprising:
providing for display a link to the resource corresponding to the particular node; and
providing for display, in associated with the link to the resource corresponding to the particular node, links to the primary resources for the resource corresponding to the particular node, without providing links to non-primary resources for display in association with the link to the resource corresponding to the particular node, wherein non-primary resources are resources in the Internet domain that are not designated as primary resources.

71. The computer-implemented method of claim 69, wherein designating resources corresponding to the one or more descendent nodes as primary resources for the resource corresponding to the particular node comprises storing information identifying the primary resource in association with information identifying the resource corresponding to the particular node.

72. A system comprising:
one or more computers and one or more storage devices storing instructions that are operable, when executed by the one or more computers, to cause the one or more computers to perform operations comprising:
generating a hierarchical sitemap of an Internet domain;
generating a score for a particular node in the generated hierarchical sitemap of the Internet domain, based at least on a position of the particular node in the generated hierarchical sitemap of the Internet domain; and
classifying a resource corresponding to the particular node as a primary resource based at least on the score for the particular node.

73-74. (canceled)

75. The system of claim 72, wherein generating the score for the particular node in the generated hierarchical sitemap of the Internet domain, based at least on the position of the particular node in the generated hierarchical sitemap of the Internet domain comprises:
generating the score for the particular node in the generated hierarchical sitemap of the Internet domain based on evaluating a quantity of descendent nodes the particular node has in the generated hierarchical sitemap of the Internet domain.

76. The system of claim 72, wherein generating the score for the particular node in the generated hierarchical sitemap of the Internet domain, based at least on the position of the particular node in the generated hierarchical sitemap of the Internet domain comprises:
generating the score for the particular node in the generated hierarchical sitemap of the Internet domain based on a distance through the generated hierarchical sitemap between the particular node and the respective nodes in the generated hierarchical sitemap of the Internet domain.

77. The system of claim 72, wherein generating the score for the particular node in the generated hierarchical sitemap of the Internet domain, based at least on the position of the particular node in the generated hierarchical sitemap of the Internet domain comprises:
generating the score for the particular node in the generated hierarchical sitemap of the Internet domain without using information indicating traffic to the resource corresponding to the particular node.

78. The system of claim 72, wherein generating the score for the particular node in the generated hierarchical sitemap of the Internet domain, based at least on the position of the particular node in the generated hierarchical sitemap of the Internet domain comprises:
evaluating a quality measure for content of the respective resource corresponding to the particular node in the generated hierarchical sitemap of the Internet domain.

79. The system of claim 72, wherein each node of the generated hierarchical sitemap of the Internet domain corresponds to a resource in the Internet domain and a position of each node in the generated hierarchical sitemap of the Internet domain is based on a path and hostname of a URL for the resource corresponding to the node.

80. The system of claim 79, wherein generating the score for the particular node in the generated hierarchical sitemap of the Internet domain, based at least on the position of the particular node in the generated hierarchical sitemap of the Internet domain comprises:
evaluating a link analysis score of the resource corresponding to the particular node of the Internet domain in the generated hierarchical sitemap of the Internet domain.

81. The system of claim 79, wherein generating the score for the particular node in the generated hierarchical sitemap of the Internet domain, based at least on the position of the particular node in the generated hierarchical sitemap of the Internet domain comprises:
evaluating a count of links from within the Internet domain to the resource corresponding to the particular node in the generated hierarchical sitemap of the Internet domain; and
evaluating a count of links from outside the Internet domain to the resource corresponding to the particular node in the generated hierarchical sitemap of the Internet domain.

82. The system of claim 79, wherein the operations comprise:
generating, for each of multiple criteria, a score for each node in the generated hierarchical sitemap of the Internet domain;
generating a combined score for each node in the generated hierarchical sitemap of the Internet domain based on the respective score for two or more of the multiple criteria;
selecting, for the particular node in the generated hierarchical sitemap of the Internet domain, one or more descendent nodes of the particular node based on the respective combined scores associated with the descendent nodes; and
designating resources corresponding to the one or more descendent nodes as primary resources for the resource corresponding to the particular node.

83. The system of claim 82, wherein the operations comprise:
providing for display a link to the resource corresponding to the particular node; and
providing for display, in associated with the link to the resource corresponding to the particular node, links to the primary resources for the resource corresponding to the particular node, without providing links to non-primary resources for display in association with the link to the resource corresponding to the particular node, wherein non-primary resources are resources in the Internet domain that are not designated as primary resources.

84. The system of claim 82, wherein designating resources corresponding to the one or more descendent nodes as primary resources for the resource corresponding to the particular node comprises storing information identifying the primary resource in association with information identifying the resource corresponding to the particular node.

85. A computer-readable storage device encoded with a computer program, the program comprising instructions that when executed by one or more computers cause the one or more computers to perform operations comprising:
generating a hierarchical sitemap of an Internet domain;
generating a score for a particular node in the generated hierarchical sitemap of the Internet domain, based at least on a position of the particular node in the generated hierarchical sitemap of the Internet domain; and
classifying a resource corresponding to the particular node as a primary resource based at least on the score for the particular node.

86. The device of claim 85, wherein each node of the generated hierarchical sitemap of the Internet domain corresponds to a resource in the Internet domain and a position of each node in the generated hierarchical sitemap of the Internet domain is based on a path and hostname of a URL for the resource corresponding to the node.

87. The computer-implemented method of claim 1, wherein each node of the generated hierarchical sitemap of the Internet domain is assigned to a level of the generated hierarchical sitemap of the Internet domain, wherein the level assigned to a node of the generated hierarchical sitemap of the Internet domain is based at least on a subdomain and a path in a URL for the resource corresponding to the node.
